(19) United States
(12) Patent Application Publication
(10) Pub. No.: US 2005/0029240 A1
(43) Pub. Date: Feb. 10, 2005

(54) Dual light source machining method and system

(75) Inventors: Mark A. Dugan, Ann Arbor, MI (US); Ali A. Said, Ann Arbor, MI (US); Philippe Bado, Ann Arbor, MI (US)

Correspondence Address: MARSHALL, GERSTEIN & BORUN LLP, 6300 SEARS TOWER, 233 S. WACKER DRIVE, CHICAGO, IL, 60606, US

(73) Assignee: TRANSLUME, INC.

(21) Appl. No.: 10/914,274

(22) Filed: Aug. 9, 2004

Related U.S. Application Data
(60) Provisional application No. 60/493,225, filed on Aug. 7, 2003.

(51) Int. Cl. B23K 26/14

(52) U.S. Cl. 219/121.82; 219/121.84

(57) ABSTRACT

Disclosed herein is a system useful for machining a workpiece, and having a first light source to generate a first beam for application to a first portion of the workpiece and ablation thereof, a second light source to generate a second beam for application to a second portion of the workpiece and heating thereof, and a positioning apparatus to direct the first and second beams to the first and second portions of the workpiece, respectively. The first light source may include a machining laser, and the second light source include a softening laser. A method of machining the workpiece includes the steps of removing a first portion of the workpiece by directing the first beam to the workpiece wherein the first beam has an intensity sufficient to ablate material from the workpiece, and heating a second portion of the workpiece to a ductile state by directing the second beam to the workpiece.

### RELATED APPLICATION

This application claims the benefit of U.S. provisional application entitled “Dual Light Source Machining Method and System,” filed Aug. 7, 2003, and having Ser. No. 60/493,225.

### BACKGROUND OF THE INVENTION

1. Field Of The Invention

The disclosure generally relates to laser-based machining methods and systems and, more specifically, to machining of a workpiece using multiple light sources.

2. Brief Description Of Related Technology

The machining of certain workpieces with long-pulse or continuous-wave (CW) lasers has been complicated by the transparency of the workpiece in the visible and near infrared (IR) wavelengths. For example, energy deposition in a glass substrate from a visible or near-IR laser is difficult, and inefficient at best, due to insignificant linear absorption of the radiation.

On the other hand, in the mid-IR to far-IR wavelengths, most common glasses absorb very strongly. FIG. 1 shows a transmission/absorption curve for a 1-cm thick block of fused silica, where absorption can be seen to increase dramatically around a wavelength of approximately 3500 nm. Radiation from mid- and far-IR lasers, such as a CO₂ laser, may be absorbed over a depth of a few tens of microns, or less.

However, the photon energy at these long wavelengths is not sufficient to ablate the portion of the workpiece substrate being machined by, for instance, breaking down the glass matrix. Rather, the workpiece substrate is laser-heated to its melting temperature, at which point material is removed through dynamic boiling. This process is associated with heat diffusion through the workpiece substrate. Such diffusion reduces the spatial accuracy of the machining process, and reduces the local temperature, thereby increasing the laser power requirement. Micro- and macro-cracks may also result from the stress effected by the heat diffusion and, more generally, the deposition of heat and associated thermal cycling. The boiling process also may contaminate the surface with hot debris (i.e., slag) that may bind strongly onto the surface, making any post-processing surface cleaning difficult.

The use of ultrafast lasers (i.e., lasers generating ultrashort, picosecond, or sub-picosecond pulses) has been proposed to micro-machine or machine glass and avoid some of the problems associated with long pulse or CW lasers. Ultrafast lasers generally do not rely on linear absorption to interact with transparent media. Rather, such lasers usually rely on non-linear absorption, a process made possible by the very high intensities associated with ultrashort pulses. Thus, ultrafast lasers can be used to machine materials like glass that are transparent in the linear regime. Laser-based processing of materials in the ultra-short regime (e.g., less than 100 picoseconds, and often less than 10 picoseconds) has been shown to offer a number of other advantages over machining using longer pulses. For instance, with ultrashort pulses, the intensity needed to ablate the material can be obtained with low energy pulses. That is, very little average power is necessary, and the energy deposition is well localized. Furthermore, material is ablated through plasma generation, a process that is relatively clean. Surface contamination is therefore much less significant relative to the damage and contamination generated by long pulse lasers.

Ultrafast laser machining has also been known to provide some improvements in surface morphology, an absence of thermal degradation, and reduced threshold fluence for polymers and inorganic materials. See Kuper et al., Appl. Phys. B 44, 2045 (1987), describing the use of sub-picosecond ultraviolet lasers in comparison with traditional nanosecond UV lasers. More generally, ultrashort lasers have been found to offer high-intensity micromachining capability for modification and processing of surfaces via multi-photon absorption, tunnel ionization, and electron-avalanche processes. See J. Ihlemann, Appl. Surf. Sci. 54 (1992) 193; Du, et al., Appl. Phys. Lett. 64 (1994) 3071; P. Pronko, et al., Optics Comm. 114 (1995) 106; Stuart, et al., J. Opt. Soc. Am B 13 (1996) 459; and, Schaffer, et al., SPIE 3616 (1999) 143. See also Herman et al. U.S. Patent Application Pub. No. 20010009250.

As shown in FIG. 1, other lasers that are readily absorbed by glass operate in the UV or deep-UV range. Deep UV lasers, such as F2 lasers, rely on linear absorption, and the energetic UV photon can break down the glass matrix. As a result, such UV lasers also machine the glass workpiece through ablation, as with ultrashort laser machining, albeit in a different manner.

However, machining with UV lasers and ultrafast lasers has been problematic. The fast, violent ablation of material during the machining of dielectrics, such as glass, has a tendency to stress the workpiece material and create micro-cracks. See, for example, Itoh et al., “Towards nano- and microprocessing in glass with femtosecond laser pulses”, Riken Review, p. 90 et seq. (January 2003). The stress and micro-cracks then may become a source of short- and long-term mechanical weakness. Further, the ablation process may leave a rough surface that is of poor quality in many contexts, including optical or microfluidic applications.

Generally, the prior art does not sufficiently teach or suggest to one of ordinary skill in the art how to realize the advantages of laser-based machining through ablation without the introduction of areas of stress, micro-cracks, and surface degradation.

### SUMMARY OF THE INVENTION

Disclosed herein is a method and system for machining a workpiece using multiple light sources. In one aspect, a method is useful for machining a workpiece. In the disclosed method, a first portion of the workpiece is removed by directing a first light beam to the workpiece that has an intensity sufficient to ablate material from the workpiece. A second portion of the workpiece is also heated to a ductile state by directing a second light beam to the workpiece.

In one embodiment, the removing and heating steps are performed concurrently. Alternatively, the heating step is performed before the removing step. And in another alternative embodiment, the heating step is performed after the removing step to reshape a region of the workpiece affected by the removing step. And in still another alternative embodiment, the heating step is performed both before and after the removing step.

The second portion may include the first portion. Alternatively, the workpiece has a region common to both of the first and second portions

In one embodiment, the first and second light beams may be directed through different surfaces of the workpiece. In another embodiment, the second light beam has a wavelength absorbed by the workpiece such that the second portion is heated to a temperature within an undercooled-melt range of temperatures.

The first light beam may deliver high-intensity pulses to the first portion sufficient for ablation but without significant melting, and the second beam provides localized heating in the second portion without ablation. The high-intensity pulses may be ultrashort such that the first light beam ablates material through non-linear absorption.

In accordance with another aspect, a system useful for machining a workpiece includes a first light source to generate a first beam for application to a first portion of the workpiece and ablation thereof, a second light source to generate a second beam for application to a second portion of the workpiece and heating thereof, and a positioning apparatus to direct the first and second beams to the first and second portions of the workpiece, respectively.

In one embodiment, the first and second beams are applied to the workpiece concurrently. Alternatively, the second beam is applied to the workpiece before the first beam is applied to the workpiece. In another embodiment, the second beam is applied to the workpiece after the first beam is applied to the workpiece to reshape a region of the workpiece affected by the first beam. In yet another embodiment, the second beam is applied to the workpiece both before and after the first beam is applied to the workpiece.

The second portion may include the first portion. Alternatively, the workpiece includes a region common to both of the first and second portions.

In one embodiment, the positioning apparatus directs the first and second beams through different surfaces of the workpiece. The second beam may have a wavelength absorbed by the workpiece such that the second portion is heated to a temperature within an undercooled-melt range of temperatures. The first beam may deliver high-intensity pulses to the first portion sufficient for ablation but without significant melting, and the second beam may provide localized heating in the second portion without ablation. The high-intensity pulses may be ultrashort such that the first beam ablates material through non-linear absorption.

In accordance with another aspect, a system for machining a workpiece includes a machining laser to generate a first beam, a softening laser to generate a second beam, and a positioning apparatus to direct the first and second beams to first and second portions of the workpiece, respectively.

The workpiece may include a region common to both the first and second portions. Alternatively, the second portion includes the first portion.

In one embodiment, the positioning apparatus may direct the first and second light beams in non-parallel fashion. Alternatively, the positioning apparatus directs the first and second light beams through different surfaces of the workpiece.

The first beam may include ultrashort pulses. The first beam may include high-intensity pulses such that the first beam delivers energy to the first portion sufficient for ablation but without significant melting. The second beam may provide localized heating in the second portion without ablation.

### BRIEF DESCRIPTION OF THE DRAWING FIGURES

For a more complete understanding of the invention, reference should be made to the following detailed description and accompanying drawing wherein:

FIG. 1 is a graph showing transmission (or absorption) characteristics as a function of wavelength of the light applied to an exemplary fused silica workpiece;

FIGS. 2A and 2B are graphs depicting volume and viscosity characteristics of an exemplary glass substrate, respectively, as a function of substrate temperature;

FIG. 3A is a schematic representation of one embodiment of a dual light source machining system acting upon a dielectric workpiece, such as glass, where the light sources are directed in parallel fashion to the workpiece;

FIG. 3B is a schematic representation of another embodiment of a dual light source machining system where the light sources are directed at different sides of the workpiece;

FIG. 3C is a schematic representation of yet another embodiment of a dual light source machining system where a heating laser is absorbed throughout the workpiece;

FIG. 3D is a schematic, plan-view representation depicting dual light source machining in accordance with one embodiment where a heating laser provides pre-and post-processing functionalities.

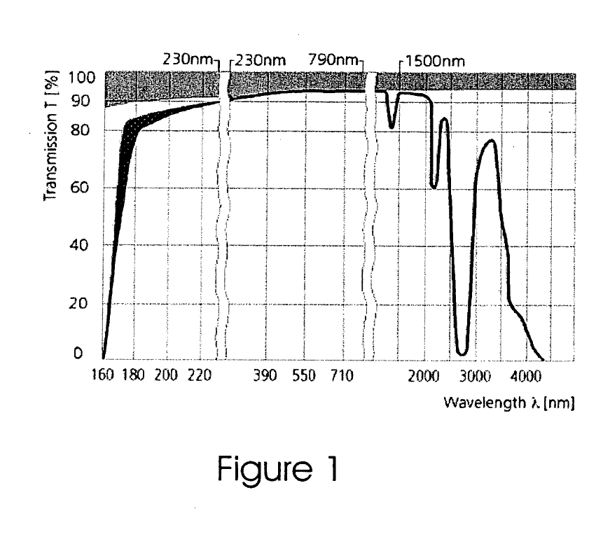

While the disclosed method and system are susceptible of embodiments in various forms, specific embodiments are illustrated in the drawing (and will hereafter be described) with the understanding that the disclosure is intended to be illustrative, and is not intended to limit the invention to the specific embodiments described and illustrated herein.

### DETAILED DESCRIPTION OF THE INVENTION

The invention generally relates to methods of machining a workpiece (or substrate) using two light sources for dual light-source excitation, together with the corresponding machining system for implementing such machining methods. More particularly, the disclosed method and system for machining incorporate a primary machining light source or laser and a secondary heating (e.g., softening) light source or laser that provides heat in and/or around the area or zone to be machined (i.e., work area). The secondary light source is thus directed to the workpiece for localized heating without ablation, and the primary light source is directed to the work zone where it provides sufficient energy for material ablation with little to no melting or heat diffusion. The localized heating of the workpiece may improve the efficiency of the ablation provided by the primary light source in certain embodiments where the localized heating is applied before or during ablation. Generally speaking, however, the localized heating improves the quality of the machining by helping to avoid or remove micro-cracks, stresses, and/or surface degradation, that would be otherwise effected or leftover by the machining of the workpiece.

In addition to improved quality, such dual excitation provides for increased machining speed. The localized warming of the workpiece may cause the work area and, in other embodiments, a region generally near that area, to become ductile. As stated above, such softening of the work area and/or the surrounding region helps prevent and/or remove cracking and stress formation, thereby improving quality. Because cracking is less likely, the energy and/or the average power of the primary machining light source may be increased, thereby increasing the speed at which the workpiece can be machined. The localized heating of the work area may also accelerate the ablation of material, further increasing the machining speed. For a given substrate material, the respective operational parameters of each light source (e.g., wavelength, energy, pulse width or duration, pulse repetition rate, and other process variables well known to those skilled in the art) may then be adjusted to optimize the improvements in machining speed and quality.

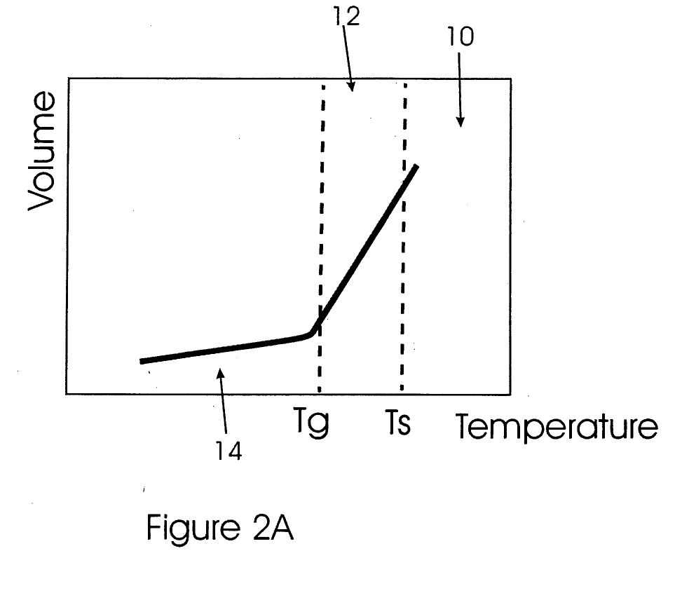

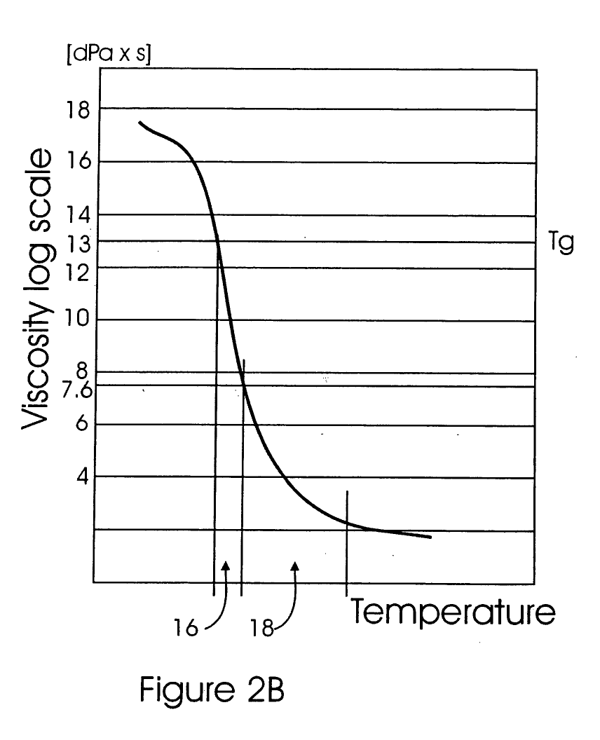

The foregoing improvements in machining quality and efficiency may be described in relation to the thermodynamic response of the workpiece material to the localized heating. To illustrate a typical thermodynamic response, two temperature response characteristics are provided in FIGS. 2A and 2B for an exemplary workpiece material, such as a generic glass. However, the illustrated response characteristics are also applicable to workpiece substrate materials other than glasses, especially other generally amorphous materials. As shown in FIGS. 2A and 2B, a typical glass workpiece material undergoes significant changes in both volume and viscosity with increasing substrate temperature before reaching the melting point, which is defined below as the onset of a melt range. FIG. 2A shows the volumetric effects of passing a typical glass workpiece through three different thermodynamics states on toward a temperature near a melting temperature (i.e., about 500 to 1800 degrees Celsius depending on the glass composition):
1. a melt state in a temperature range indicated generally at 10 and above about the liquidus temperature (Ts);
2. an undercooled melt state in a temperature range indicated generally at 12 and between about the liquidus temperature (Ts) and about the setting temperature (Tg); and,
3. a frozen melt state in a temperature range indicated generally at 14 and below about the setting temperature (Tg);
   (where the setting temperature (Tg) is also referred to as the transformation temperature). For example, the liquid is and setting temperatures for borosilicate BK7 glass are about 720 degrees Celsius and 560 degrees Celsius, respectively.

With reference now to FIG. 2B, as a typical melted glass cools, the viscosity increases. Viscosity in the melt range 10 is typically on the order of about 10⁰ to about 10⁴ dPa s (i.e., where 1 dPa s=1/10 Pascal-seconds or 1 Poise). Between the orders of about 10⁴ and about 10^{7.6} dPa s, the glass can be described as “viscous,” and as “plastic” when between about 10^{7.6} to about 10¹³ dPa s. Note that viscosity proves to be increasingly dependent on time above about 10⁹ dPa s. The delay in the achievement of decisive structural equilibrium becomes so great as the viscosity increases (and the temperature decreases) that the glass can be considered to have solidified above about 10¹³ dPa s. The corresponding steady state temperature is the transformation temperature or setting temperature referenced above in connection with FIG. 2A.

Bringing the glass above the transformation temperature, by as little as 10 degrees Celsius, will release internal stress, as may be done in the annealing of a glass. The glass starts to deform under its own weight once it reaches its softening point (defined in certain industry applications as the point where viscosity is equal to 10^{7.6} Pa s).

The softening point and the transformation point are separated by one operating temperature range indicated generally at 16 in FIG. 2B of approximately 50 to 200 degrees Celsius in the most common optical glasses (such as BK7). This operating temperature range 16 corresponds with a portion of the temperature range 12 shown in FIG. 2A between the melt range 10 and the frozen melt range 14. Another portion of the temperature range 12 corresponds with another operating temperature range indicated generally at 18 that extends above the softening point, and may result in slight workpiece material movement, and even a slight degree of melting. Traditionally, one would want to avoid the heating of a glass workpiece much above the softening point to prevent unwanted physical deformation (except of course when melting is desired). This is particularly the case when global heating of the workpiece would occur. However, with the localized heating provided by the secondary light source, one may operate significantly above the softening point without encountering significant physical deformation issues. Nevertheless, it is well known to those skilled in the art that viscosity is drastically reduced as the glass goes through the softening point.

The secondary laser provides heating in a controlled and localized manner to exploit the machining advantages presented by these thermodynamic ranges. In one embodiment, the secondary laser may be directed to the workpiece to focus energy in a region that reaches a temperature that remains within the operating temperature range 16. Alternatively, the secondary laser may be directed to the workpiece in a manner that causes a region to exceed the softening temperature. The localized nature of that heating, however, helps limit any melting to desired locations and/or prevent any melting in other locations.

In one embodiment, the secondary light source is a CO₂ or similar laser absorbed very strongly by the workpiece material. Such strong absorption helps localize the heating effect of the secondary laser. CO₂ lasers, for instance, operate at a wavelength of about 10 microns, a region where most glasses, including fused silica, absorb very strongly. Thus it is possible to deposit energy (i.e., heat) in a relatively localized segment or region of the glass substrate using a CO₂ laser. The absorption is very strong such that all the energy (heat) is deposited in the very first layer of depth, the limitation along the other two axes being determined from the limited size (cross-section) of the beam.

Localized heating helps control the application of energy spatially, which in turn helps control the magnitude or degree of heating in any one particular region, portion or area of the workpiece. A controlled approach to heating a portion of the workpiece then helps manage the heating or softening process. That is, it becomes easier to heat the workpiece portion to a target point within the operating range 16, i.e., a temperature in an approximate range bounded by the setting temperature, Tg, and the softening point, or to a target point at any other temperature.

As shown in FIG. 2B, the operating range 16 provides a very wide fluctuation in material viscosity. Between the melting point and normal room temperature, a typical glass material passes through a viscosity range of 15-20 powers of ten, as shown on the log scale of FIG. 2B. This variability provides a great deal of room for softening, annealing, etc. via the secondary light source, and therefore a relatively easy operational task of heating the substrate to a ductile state without unwanted modification or damage.

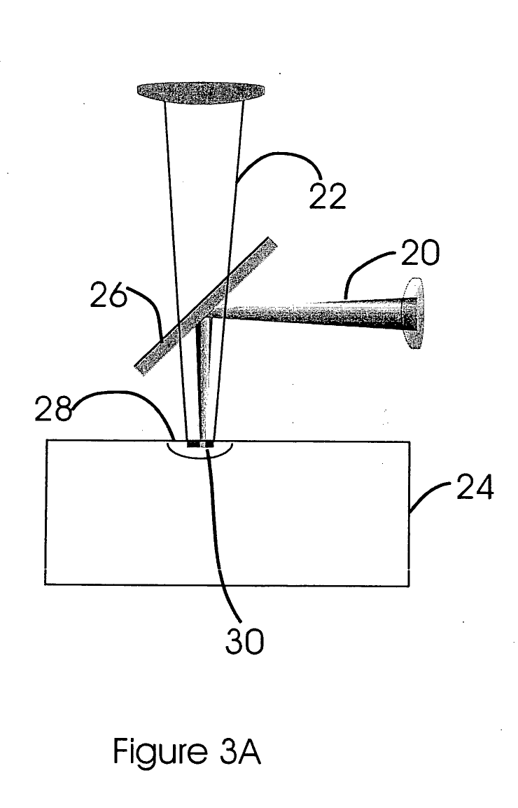

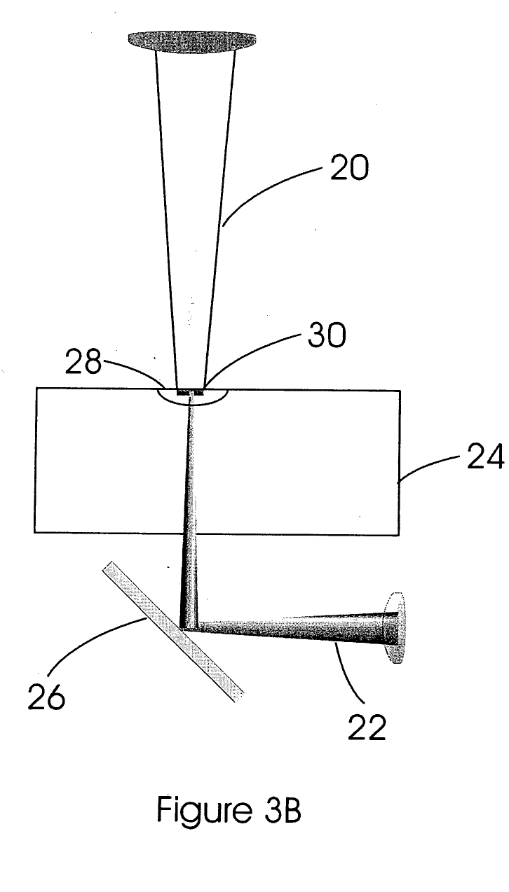

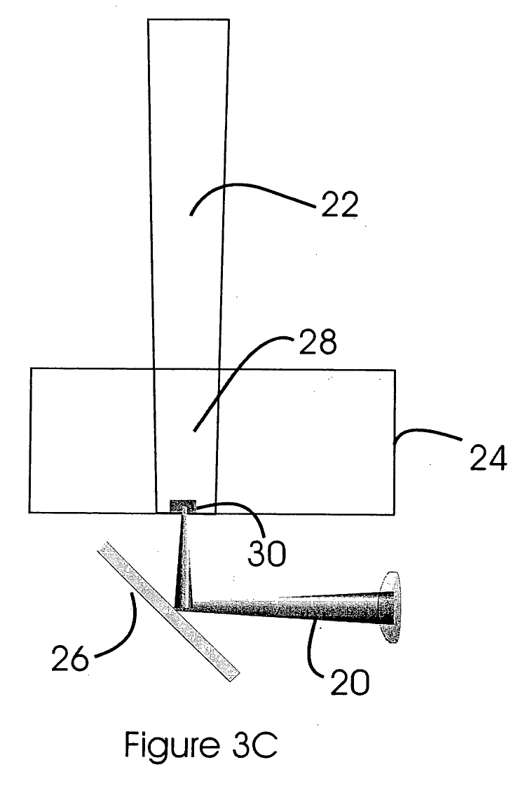

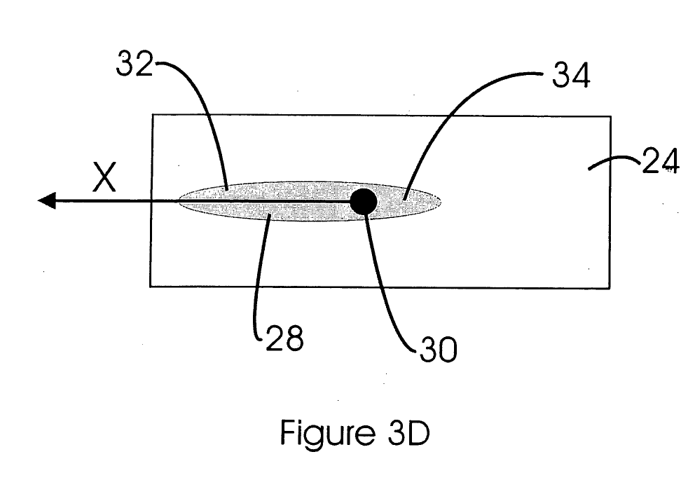

Application of the low-intensity beam of the secondary light source, which may be a laser, is either concurrent with, before, or after an ultrafast or other machining laser is directed to the work area to ablate workpiece material, as shown in FIGS. 3A, 3B, and 3C. If the secondary light source is applied first (or otherwise sufficiently early) to the portion of the workpiece to be ablated, the softened glassy material will be ablated all the more easily. With the heated glass being ductile instead of brittle, the formation of micro-cracks is significantly prevented despite the intensity of the machining laser. The secondary laser also removes or eliminates micro-cracks, stresses, and other degradations when applied after the ablation of workpiece material, where, in contrast, a femtosecond, deep-UV, or other high-intensity laser alone would create and leave such undesirable imperfections.

Another advantage of one embodiment of the combination of the machining and heating light sources is that the possibility of heat diffusion associated with using a CO₂ or similar laser alone is also significantly reduced, inasmuch as the temperature may be maintained well below the softening point. Stated differently, there is little, if any, thermal mass that reaches hot temperatures, because any hot material is rapidly removed by the ultrafast lasers, thereby further preventing heat diffusion. In this way, the combination of a CO₂ laser with an ultrafast laser to machine glass avoids the known shortcomings of prior machining methods and systems that relied on non-high-intensity light sources.

FIG. 3A shows an exemplary embodiment of the machining system for practice of one embodiment of the machining method where the light sources and optics (not shown) are set up such that a primary, machining beam 20 and a secondary, heating beam 22 are applied to a workpiece 24 coincidentally in space, and in parallel fashion. An optics bench (not shown) and/or other optics positioning apparatus known to those skilled in the art and indicated schematically at 26 are used to direct the beams 20 and 22 as such. The two light beams 20, 22 may strike the workpiece coincidentally in time as well, or with, for instance, the heating beam 22 striking the work area for a predetermined period of time to achieve a desired degree of heating over a desired region referred to herein as a heated zone 28. The heated zone or region 28 may include or encompass a work area or region 30 from which a portion of the workpiece 24 will be removed. As shown in FIG. 3A, the heated zone 28 may extend beyond the work area 30 in any dimension or direction, as desired, and as established by the focusing optics associated with the beam 22.

The first beam 20 includes pulses having an intensity suitable for material ablation, and may include ultrashort pulses in certain embodiments. In contrast to a high-intensity beam, the second beam 22 may have a wavelength that is readily absorbed by the material of the workpiece 24 to facilitate the transfer of energy to the heated region 28 of the workpiece 24 for efficient creation thereof. This heating, softening, or smoothing step, selectively and controllably raises the temperature of the heated region 28 to place the heated region in a ductile state suitable for one or more of annealing, remelting, reshaping or smoothing, stress and/or micro-crack removal or prevention, or heating generally. To these ends, the heated region 28 may, but need not, correspond with the work area 30, and may be created before, after, or during (or some combination thereof) the machining of the work area 30. If, for example, the second beam 22 is applied in a remelting or shaping step that heats the work area 30 to a plastic state, the second beam 22 may be used to improve, for example, smoothness. Another example of a post-machining application of the heated region 28 corresponds with an annealing or other physical modification that does not result in any smoothing.

FIG. 3B, where elements similar to those shown in previously described figures are identified with like reference numerals, shows an alternative embodiment of the machining system where the primary beam 20 illuminates the softened zone from a different direction, such as from the back (or opposite side) of the workpiece 24. Such backside ablation utilizes the transparency (in the linear regime) of the unfocused femtosecond laser beam. The use of the second beam 22 enables this approach to drilling or other machining of the workpiece 24, because otherwise such backside ablation is very susceptible to undesirable crack formation.

In accordance with an alternative embodiment, the CO₂ laser that may generate the second beam 22 is replaced by a laser or other light source that is not absorbed as immediately. In the exemplary embodiment shown in FIG. 3C, the secondary, heating beam 22 is shown to be relatively uniformly absorbed throughout the workpiece 24, although uniformity of absorption is not necessary for practice of the disclosed method and system. In either case, the heated region 28 created in this embodiment may be in the shape of a large cylinder. The femtosecond or other high-intensity laser generating the primary, machining beam 20 may then illuminate one or more portions of this enlarged heated zone 28 from the back side of the workpiece 24 (as shown) or from any other direction.

Generally speaking, because the two light beams 20 and 22 are generated from two, different sources, and may pass through different optical systems, the beams 20, 22 may be directed to the machining area either coincidentally in both time and space, sequentially, or with an inclination to one another (i.e., non-parallel beams). While the directionality, focal point, and other spatial characteristics of the two light beams 20 and 22 may be modified to practice the disclosed method and system, it should be noted that the workpiece 24 is disposed in a holder component of a positioning system or apparatus that may provide positioning capability, such that it is capable of both rotating and/or translating the workpiece 24 relative to the light beams 20 and 22.

The positioning system may include an optical system, which in turn may include optical scanners and deflectors and other devices well known to those skilled in the art. Generally speaking, the positioning system adjusts the paths of the primary and secondary beams. The positioning system may also include a stepper or other positioner that translates, rotates or otherwise positions the substrate or workpiece.

The positioning system may position the workpiece or substrate relative to the primary and secondary light sources such that the high and low intensity light beams are parallel and coincident in space (e.g., directed along the same line toward the substrate). Alternatively, the positioning system may position the workpiece or substrate relative to the primary and secondary light sources such that the high and low intensity light beams are offset from each other. The high and low intensity light beams need not be parallel to each other, and their respective spot sizes may differ to account for heat diffusion (e.g., a low-intensity spot size smaller than the work area) or more aggressive crack prevention (e.g., a low-intensity spot size larger than and encompassing the work area). Neither beam need strike the substrate orthogonally.

The timing and sequencing of the incidence or application of the high and low intensity beams may also be adjusted. They may be applied coincidentally (i.e., concurrently), or the application of the high intensity beam may occur after the incidence of the low intensity beam. Such delayed incidence of the high intensity beam may allow for full or partial absorption of the low intensity beam and a period of heat diffusion to cover an area coincident to, or larger than, the working area (i.e., area to be machined). The application of the low intensity beam may only partially occur prior to the incidence of the high intensity beam, such that the low intensity beam is also applied after the pulses of the high intensity beam. Such application provides heating in a post-machining context for smoothing and other improvements to the working area.

With reference now to FIG. 3D, the temporal sequence of the application of the two light sources may be adjusted to suit the material being processed. In the exemplary schematic of FIG. 3D, the machining of the workpiece 24 is shown to include the work area 30 progressing in a direction X. In preparation for such machining by the primary beam 20 (FIGS. 3A-3C), the secondary beam 22 (FIGS. 3A-3C) is directed to a softening zone 32 included within the heated region 28. In this embodiment, however, the secondary beam 22 is also directed to apply heat after the ablation has occurred. As a result, the heated region 28 also includes a smoothing zone 34.

The manner in which the secondary beam 22 is applied to both the softening zone 32 and the smoothing zone 34 is a matter of system and method design choice well known to one skilled in the art. For instance, the optical components and other positioning apparatus 26 may be used to generate multiple portions of the secondary beam 22 for directing energy to both of the zones 32 and 34 at the same time. Alternatively, energy may be alternating between the two zones 32 and 34.

More generally, the turn on/turn off time for each light source or laser responsible for generating the first and second beams 20 and 22 may also be adjusted to suit the workpiece material and machining task presented, and furthermore be adjusted independently of one another. For example, the heat diffusion associated with the secondary light source may take a microsecond (or fraction thereof) to spread over the softening zone 32 or other region of interest. Spatial location of each beam may also be adjusted independently. For example, to compensate for heat diffusion, the CO₂ laser or other secondary light source generating the heating beam 22 may illuminate a slightly smaller zone than that illuminated by the femtosecond laser, even though the softened zone 32 or smoothing zone 34 may extend beyond the work area 30.

Generally speaking, however, the heating beam 22 provided by the CO₂ laser or other light source may be used independently of the positioning or timing associated with the machining beam 20 and, more particularly, be applied in any combination of pre- and/or post-processing of the workpiece 24 to, for example, soften the workpiece material to a ductile state in preparation for machining, or smooth any irregularities and/or remove residual stress.

The primary light source is preferably an ultrafast laser, such that the light source generates laser pulses having a pulse width in the femtosecond, picosecond, or sub-picosecond range. In an alternative embodiment, the primary light source is a nanosecond laser. The secondary light source may be a long-pulse or continuous laser with high average power, but preferably insufficient intensity to raise the workpiece to a temperature at which the material is undesirably damaged, which will depend on the relative rates of heat removal through diffusion and heat deposition via the secondary light source. As described above, in some embodiments, the secondary light source is a CO₂ laser. The power ratio between the primary and secondary light sources, such as the femtosecond laser and the CO₂ laser, respectively, may be adjusted to suit the material being processed. The CO₂ laser may operate in about the 1 W range, but may be as high as the kilowatt range. Femtosecond lasers for use in connection with this system generally operate around a few Watts, and operation at a number of wavelengths known to those skilled in the art would be suitable for material ablation in accordance with the disclosed method. A suitable pulse width for ablation of glass and other dielectric materials would be below about 100 ps, with a more preferred range being below about 10 ps, while a suitable CO₂ pulse width for such applications of the disclosed method may be in the range of about 10 ns to continuous.

The process may be fully computerized to automate the relative positioning of the light sources and workpiece 24. As is well known in the art, software-controlled translation or other movement of the beams 20, 22 or workpiece 24 allows for efficient processing.

The workpiece 24 may include a dielectric substrate material, such as glass, or any other material that undergoes a range of viscosities between its setting temperature and its melting temperature, such that an operating range of temperatures may be defined. A temperature within that range is then reached as a result of the application of the low intensity light beam 22.

The foregoing dual light source machining techniques set forth an improved method for machining or micromachining glass and other workpieces having transmission/absorption characteristics rendering the material difficult to machine. High precision micromachining of such workpieces is important in connection with the manufacture and performance of telecommunication devices (such as I/O ports, resonant micro-cavity, e-o receptacles, active devices, etc.) and microfluidic systems. For glass micromachining, the combination of a CO₂ laser and a femtosecond laser is described herein, but the disclosed technique may be extended to other dielectric materials and light sources as well. With differing glass and other workpiece materials, for example, replacement of the CO₂ laser with a different light source or laser may be warranted when the replacement radiation (wavelength) is more optimally absorbed.

The foregoing methods and system for machining a workpiece may be applied to a variety of substrate materials that may be heated in preparation for machining. Practice of the machining methods and system is therefore not limited to the machining of glass or other dielectrics. Rather, such machining may be applied to any substrate material (e.g., ceramics, semiconductors, etc.) that is capable of absorbing light source energy for heating without melting in preparation for, or concurrent with, machining using a high-intensity laser. Such materials generally are viscous over a large temperature range as set forth above, and preferably capable of being locally heated to a ductile state. Such machining will also provide significant advantages with those materials, such as glassy materials, that exhibit a propensity for cracking with prior laser-based machining techniques.

The foregoing are but a few of the ways and techniques in which machining methods and systems involving the use of an ultra-short pulse laser beam in conjunction with a heating laser can improve the machining process. Those of ordinary skill in the relevant art will recognize other beneficial applications of these techniques in improving machining performance and quality. Any of the disclosed techniques could be combined with other disclosed techniques to further improve machining methods and systems.

The terms “high-intensity pulses” or “high-intensity beam” are used herein to refer broadly to any pulse sequence in a light beam, or other light beam portion if non-pulsed, having the capability to remove workpiece material through ablation (as opposed to melting or dynamic boiling), but without regard to the manner in which the material is ablated. For example, the high-intensity beam or pulses may, but need not, generate a plasma in removing workpiece material. The high-intensity pulses or beam from certain light sources, such as an ultrafast laser, may, but need not, also advantageously direct energy to the workpiece 24 through high-intensity pulses in a localized manner, i.e., one that ablates workpiece material without significant diffusion of heat away from the work area 30.

The terms “low-intensity” or “low-intensity beam” are used herein to refer broadly to any portion of a light beam or other radiation from a light source suitable for heating of the workpiece material without ablation. More particularly, the heating involves raising a portion of a workpiece to a temperature at which the material has entered a ductile state. The low-intensity beam or pulses may, but need not, eventually lead to melting of the workpiece material.

The terms “ductile” and “ductile state” are used herein to refer to any heating of a material where, for example, a portion of the material becomes capable of a certain degree of plastic deformation, but not necessarily deformation under its own weight. In certain instances, a material may enter a ductile state in conjunction with a certain degree of melting or softening occurring therewith. As a result, the melting, movement or softening of the workpiece material should not be understood to be mutually exclusive of a material entering a ductile state. Nevertheless, in certain embodiments, melting may be desirably avoided.

The foregoing description is given for clearness of understanding only, and no unnecessary limitations should be understood therefrom, as modifications within the scope of the invention may be apparent to those having ordinary skill in the art.

1. A method of machining a workpiece, comprising the steps of:
removing a first portion of the workpiece by directing a first light beam to the workpiece wherein the first light beam has an intensity sufficient to ablate material from the workpiece; and
heating a second portion of the workpiece to a ductile state by directing a second light beam to the workpiece.

2. The method of claim 1, wherein the removing and heating steps are performed concurrently.

3. The method of claim 1, wherein the heating step is performed before the removing step.

4. The method of claim 1, wherein the heating step is performed after the removing step to reshape a region of the workpiece affected by the removing step.

5. The method of claim 1, wherein the heating step is performed both before and after the removing step.

6. The method of claim 1, wherein the second portion comprises the first portion.

7. The method of claim 1, wherein the workpiece comprises a region common to both of the first and second portions.

8. The method of claim 1, wherein the first and second light beams are directed through different surfaces of the workpiece.

9. The method of claim 1, wherein the second light beam has a wavelength absorbed by the workpiece such that the second portion is heated to a temperature within an undercooled-melt range of temperatures.

10. The method of claim 1, wherein the first light beam delivers high-intensity pulses to the first portion sufficient for ablation but without significant melting, and wherein the second beam provides localized heating in the second portion without ablation.

11. The method of claim 10, wherein the high-intensity pulses are ultrashort such that the first light beam ablates material through non-linear absorption.

12. A system for machining a workpiece, comprising:
a first light source to generate a first beam for application to a first portion of the workpiece and ablation thereof;
a second light source to generate a second beam for application to a second portion of the workpiece and heating thereof;
a positioning apparatus to direct the first and second beams to the first and second portions of the workpiece, respectively.

13. The system of claim 12, wherein the first and second beams are applied to the workpiece concurrently.

14. The system of claim 12, wherein the second beam is applied to the workpiece before the first beam is applied to the workpiece.

15. The system of claim 12, wherein the second beam is applied to the workpiece after the first beam is applied to the workpiece to reshape a region of the workpiece affected by the first beam.

16. The system of claim 12, wherein the second beam is applied to the workpiece both before and after the first beam is applied to the workpiece.

17. The system of claim 12, wherein the second portion comprises the first portion.

18. The system of claim 12, wherein the workpiece comprises a region common to both of the first and second portions.

19. The system of claim 12, wherein the positioning apparatus directs the first and second beams through different surfaces of the workpiece.

20. The system of claim 12, wherein the second beam has a wavelength absorbed by the workpiece such that the second portion is heated to a temperature within an undercooled-melt range of temperatures.

21. The system of claim 12, wherein the first beam delivers high-intensity pulses to the first portion sufficient for ablation but without significant melting, and wherein the second beam provides localized heating in the second portion without ablation.

22. The system of claim 12, wherein the high-intensity pulses are ultrashort such that the first beam ablates material through non-linear absorption.

23. A system for machining a workpiece, comprising:
a machining laser to generate a first beam;
a softening laser to generate a second beam; and
a positioning apparatus to direct the first and second beams to first and second portions of the workpiece, respectively.

24. The system of claim 23, wherein the workpiece comprises a region common to both the first and second portions.

25. The system of claim 23, wherein the second portion comprises the first portion.

26. The system of claim 23, wherein the positioning apparatus directs the first and second light beams in non-parallel fashion.

27. The system of claim 23, wherein the positioning apparatus directs the first and second light beams through different surfaces of the workpiece.

28. The system of claim 23, wherein the first beam comprises ultrashort pulses.

29. The system of claim 23, wherein the first beam comprises high- intensity pulses such that the first beam delivers energy to the first portion sufficient for ablation but without significant melting.

30. The system of claim 23, wherein the second beam provides localized heating in the second portion without ablation.
